(19) United States
(12) Patent Application Publication
(10) Pub. No.: US 2017/0103059 A1
(43) Pub. Date: Apr. 13, 2017

(54) METHOD AND SYSTEM FOR PRESERVING SENSITIVE INFORMATION IN A CONFIDENTIAL DOCUMENT

(71) Applicant: INTERNATIONAL BUSINESS MACHINES CORPORATION, ARMONK, NY (US)

(72) Inventors: KEKE CAI, BEIJING (CN); HONG LEI GUO, BEIJING (CN); ZHILI GUO, BEIJING (CN); FENG JIN, BEIJING (CN); ZHONG SU, BEIJING (CN)

(21) Appl. No.: 14/877,973

(22) Filed: Oct. 8, 2015

(51) Int. Cl. G06F 17/27; G06F 21/62; G06F 17/22

(52) U.S. Cl. CPC G06F 17/277; G06F 17/2241; G06F 17/278; G06F 17/2229; G06F 21/6245

(57) ABSTRACT

Method and system for preserving confidential information in a sensitive document. The method includes: obtaining a first entity and a second entity from a document, building a first context feature from the first entity and a second context feature from the second entity based on a semantic analysis, determining that the extent of similarity between the first and second context features exceeds a predefined threshold, and replacing the first entity with the second entity in response to a similarity determination. The present invention also provides a computing system for preserving confidential information in a sensitive document.

### BACKGROUND OF THE INVENTION

Nowadays, enterprises are more concerned with security issues regarding their confidential documents. Usually, documents such as contracts and/or agreements of enterprises are subjected to several rounds of amendments. For example, an original version drafted by an attorney in an enterprise will be reviewed by other professionals such as an attorney in a law firm and/or an accountant in an accounting firm. The information related to trade secrets and/or technical secrets included in the document, if any, would probably be revealed to irrelevant persons in the review procedure by outside persons.

With developments of semantic recognition and word processing technologies, sensitive information can be identified from the document. Although some solutions have been proposed to replace the sensitive information with wildcard characters or other predefined strings, these solutions can cause confusion and a reader can possibly be distracted by these wildcard characters and fail to focus on the main idea of the document.

### SUMMARY OF THE INVENTION

The present invention provides a computer-implemented method for preserving sensitive information in confidential documents. The method includes: obtaining a first entity and a second entity from a document, building a first context feature from the first entity and a second context feature from the second entity based on a semantic analysis, determining that the extent of similarity between the first and second context features exceeds a predefined threshold, and replacing the first entity with the second entity in response to similarity determination.

Another aspect of the present invention provides a computing system for preserving sensitive information in confidential documents. The computing system includes: a processor device coupled to a computer-readable memory unit, the memory unit including a module having instructions that when executed by the computer processor implements a method. The method includes: obtaining a first entity and a second entity from a document, building a first context feature from the first entity and a second context feature from the second entity based on a semantic analysis, determining that the extent of similarity between the first and second context features exceeds a predefined threshold, and replacing the first entity with the second entity in response to similarity determination.

The present invention also provides a computer readable non-transitory article of manufacture tangibly embodying computer readable instructions which, when executed, cause a computer to carry out the steps of a method. The method includes: obtaining a first entity and a second entity from a document, building a first context feature of the first entity and a second context feature of the second entity based on a semantic analysis, determining that the extent of similarity between the first and second context features exceeds a predefined threshold, and replacing the first entity with the second entity in response to similarity determination.

### BRIEF DESCRIPTION OF THE DRAWINGS

Through the more detailed description of some embodiments of the present invention in the accompanying drawings, the above and other objects, features and advantages of the present invention will become more apparent.

FIG. 1 schematically illustrates an example computer system/server 12 which is applicable to implement embodiments of the present invention;

FIG. 2 schematically illustrates an example document to which embodiments of the present invention can be applied;

FIG. 3 schematically illustrates a block diagram for preserving sensitive information in a confidential document according to one embodiment of the present invention;

FIG. 4 schematically illustrates a flowchart of a method for preserving sensitive information in a confidential document according to one embodiment of the present invention;

FIG. 5 schematically illustrates a diagram of a hierarchical structure of a document according to one embodiment of the present invention;

FIG. 6 schematically illustrates a block diagram of a data structure of a context feature according to one embodiment of the present invention;

FIG. 7 schematically illustrates a block diagram of a data structure of a context dimension according to one embodiment of the present invention; and

FIG. 8 schematically illustrates an example document after preserving sensitive information in a confidential document according to one embodiment of the present invention.

Throughout the drawings, same or similar reference numerals represent the same or similar elements.

### DETAILED DESCRIPTION OF THE PREFERRED EMBODIMENTS

Principle of the present invention will now be described with reference to some example embodiments. It is to be understood that these embodiments are described only for the purpose of illustration and help those skilled in the art to understand and implement the present invention, without suggesting any limitations as to the scope of the invention. The invention described herein can be implemented in various manners other than the ones describe below.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, can be included below.

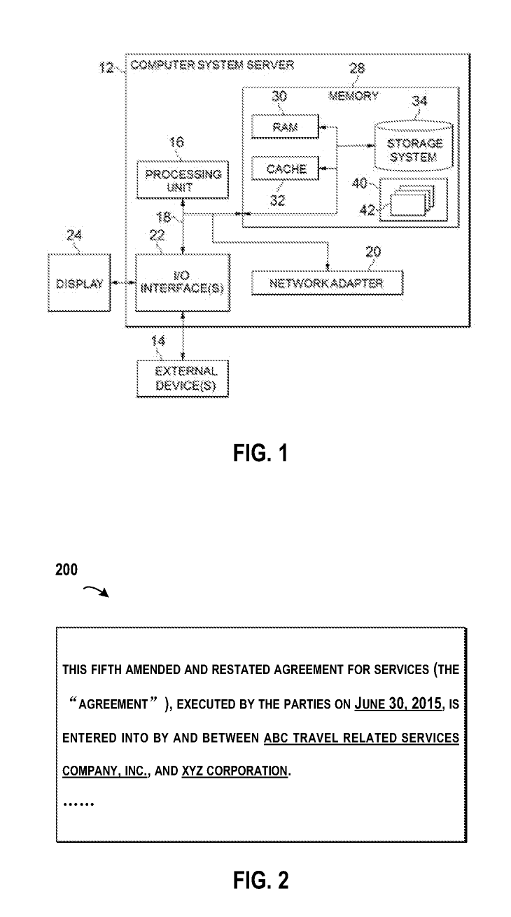

Reference is first made to FIG. 1, in which an example electronic device or computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 can include: one or more processors or processing units 16, system memory 28, and bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, and the like. One or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include: microcode, device drivers, redundant processing units, external disk drive arrays, RAID systems, tape drives, and data archival storage systems, etc.

FIG. 2 schematically illustrates example document 200 to which embodiments of the present invention can be applied. For the purpose of illustration, embodiments of the present invention are described by taking an agreement as an example document. Examples of document include: legal agreements and/or contracts. Embodiments of the present invention are also applicable to other types of documents such as a technical report, an analysis report, and so on. In FIG. 2, some sensitive information (the underlined portions in the document 200) related to trade secrets should be preserved. Such information can be automatically identified and/or specified by a human user.

In order to preserve the sensitive information, one conventional approach searches the document for predefined keywords so as to obtain sensitive information such as a starting time of a contact, a price of a product and an address of a service provider in the document. Then the obtained sensitive information is replaced with wildcard characters or other predefined strings. For example, the name of each month can be searched in the document to find sensitive date.

With respect to example document 200 in FIG. 2, “June,” “company,” and “corporation” can be used as the keywords, and then the original date of “Jun. 30, 2015” can be modified to “MM DD, YYYY.” Further, the name of the two companies “ABC travel related services company, inc.” and “XYZ corporation” can be replaced with “COMPANY A” and “COMPANY B.” Although this approach can preserve the sensitive information in the document, multiple portions of the document are replaced with strings such as “MM DD, YYYY,” “COMPANY A,” and “COMPANY B.” As a result, confusion will be caused in understanding the document because the role of “COMPANY A” in the agreements is unclear. Moreover, the reader may be distracted by these wildcard characters and fail to focus on the main idea of the document.

In another known approach, substitute words for the sensitive information can be predefined. However, depending on the specific context in the contract, a same word can have different meanings. For example, in a contract for mergers and acquisitions, one company can serve as different roles. For example, the company can represent not only a buy side in one portion of the contract, but also a sell side in another portion of the contract. In order to distinguish the exact meaning of the sensitive words, manual works are required to parse the semantic aspect of the context of the sensitive words so as to find appropriate words for substituting the sensitive words.

Embodiments of the present invention solve the above and other potential problems in the conventional approaches. For a document to be processed, a first entity and a second entity are obtained from the document, a first context feature of the first entity and a second context feature of the second entity are built based on a semantic analysis, the extent of similarity between the first and second context features are determined to exceed a predefined threshold, and the first entity is replaced with the second entity in response to the similarity determination.

Examples of the target information to be preserved include a name of an organization, a date, a price, a numerical value, a currency, and/or any other sensitive information. It would be appreciated that although embodiments of the present invention are described by taking the sensitive information as example target information, the target information can be of any information concerned by the user, and thus the target information can be defined and modified depending on the requirements.

In the embodiments of the present invention, although descriptions are presented with a document written in English, the technical solution of the present invention can also be applied to another document written in another language. For example, a document written in Chinese can be processed according to the present invention, at this point the lexical analysis and the semantic analysis should follow Chinese linguistics rules.

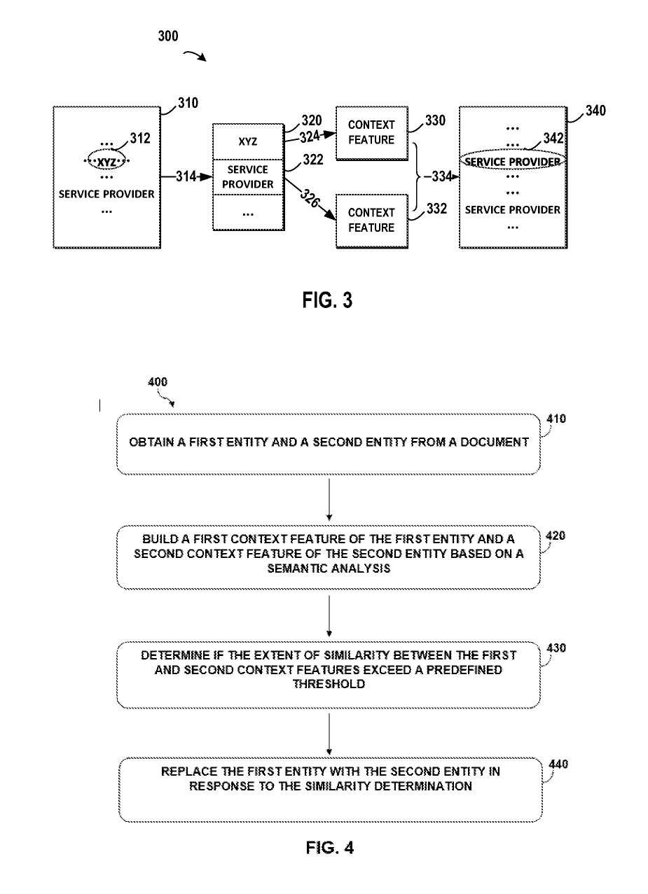

FIG. 3 schematically illustrates a block diagram for preserving sensitive information in a confidential document according to one embodiment of the present invention. In FIG. 3, document 310 including some target information (for example, the company name “XYZ”) needs to be replaced. According to the embodiment, candidates for the target information can be identified from document 310. For example, if the name of the company is predefined as the target information, then the terms such as “XYZ” and “service provider” are identified (314).

At this time, “XYZ” is identified as first entity 320 and “service provider” is identified as second entity 322. Then, context feature 330 of first entity 320 is built (324) and context feature 332 of second entity 322 is built (326) according to a semantic analysis of document 310. After that, context features 330 and 332 are compared to determine the similarity between them. As context features 330 and 332 are respectively built from the context of first entity 320 and second entity 322 in document 310, the similarity between context features 330 and 332 can indicate the consistency degree of the two entities to a great extent. In other words, if the similarity is high, then first entity 320 and second entity 322 can have the same meaning in document 310. Otherwise, first and second entities 320 and 322 can indicate different concept. In response to the similarity exceeding a predefined threshold, the original term “XYZ” indicated with reference number 312 in original document 310 is replaced with the term “service provider” 342 in document 340.

Details of embodiments of the present invention will be described with reference to FIG. 4, which schematically illustrates a flowchart of a method for preserving sensitive information in a confidential document according to one embodiment of the present invention. In Step 410, a first entity and a second entity are obtained from the document. Rules for obtaining the first and second entities can be predefined based on objectives of information preserving according to a lexical analysis. For example, if the information related to potential trade secrets is expected to be preserved, then the entities can be selected from terms indicating a name of a company, a date and so on. As another example, if technical details are expected to be preserved, then the entities can be selected from numbers which possibly indicate technical parameters.

It would be appreciated that the first and the second entities can be obtained automatically or manually from the document. Further, if the document is one of a serial of agreements for a same subject matter, the first and the second entities from one document can be manually obtained for preserving the same target information in another document.

For the purpose of illustration, several paragraphs related to preserving sensitive information in confidential documents are provided in Table 1. Occurrences of the obtained entities are illustrated in bold.

TABLE 1
Example of Document

| Paragraph | |
|---|---|
| No. | Content |
| . . . | . . . |
| [0035] | “Customer Production Ready Date” or “CPRD” means the date |
| | (following the Hosting Service Ready Date) that the following items have |
| | been completed: (1) Customer has notified XYZ that Customer has |
| | completed application testing and loading of Customer Content, and (2) |
| | XYZ has notified Customer that monitoring and reporting have been |
| | enabled and end users can now begin using the Services. |
| . . . | . . . |
| [0065] | On Jun. 30, 2015, Company ABC notified XYZ in writing that it has |
| | completed application testing and loading of . . . pursuant to Section |
| | 13.2(b) . . . |
| [0066] | XYZ has notified Company ABC in writing that monitoring and reporting |
| | have been enabled and end users can now begin using the Services. |
| . . . | . . . |
| [0100] | Subject to Section 9.5, Supplier shall provide the Services using current |
| | technologies and business processes that are consistent with the industry |
| | established standards and practices of well-managed outsourcing service |
| | providers providing services similar to the Services set forth in a |
| | Supplement to this Agreement including technology, processes, and other |
| | characteristics of the Services under this Agreement that will help the |
| | Eligible Recipients to take advantage of the advances in the industry and |
| | support their efforts to maintain competitiveness in their markets. |
| [0101] | With respect to a Supplement with a Supplement Term of 5 years or |
| | more, commencing on the date twenty-four (24) months after the |
| | scheduled completion date of the applicable Transition Plan, and not |
| | more than once every eighteen months during the initial Term of any |
| | Supplement, Customer can, at its expense, engage the services of an |
| | independent third party (a “Price Benchmarker”) to compare the cost of all |
| | or any Tower of the Services against the cost of five (5) or more other well |
| | managed service providers performing similar services using the |
| | methodology set forth in Exhibit 6 to the applicable Supplement or if none |
| | is set forth then agreed to by the Parties in accordance with the applicable |
| | Governance Process to ensure that Customer is receiving from Supplier |
| | pricing that are competitive with market rates, and prices, given the |
| | nature, quality, volume and type of Services provided by Supplier |
| | hereunder (“Price Benchmarking”). |
| [0102] | In addition, as of the Contract Start Date, Service Provider will begin |
| | delivering Services in a business-as-usual (“BAU”) manner as provided |
| | prior to the Effective Date. From the start of the Transition activities |
| | through the completion of the Transition implementation (the “Transition |
| | Period”), Service Provider will migrate the Services from the current |
| | BAU environment to the Service Provider's steady state environment, |
| | including migrating current workload to Service Provider's global delivery |
| | centers. |
| . . . | . . . |
| [0110] | All services and processes to deliver the first transition methodology and |
| | to migrate into the XYZ data center are effective in two months. |
| . . . | . . . |

In the document illustrated in Table 1, a plurality of entities with different types can be obtained, and the obtained entities can be stored into a data structure shown in Table 2 as below.

TABLE 2
Data Structure for Storing Obtained Entities

| No. | Entity |
|---|---|
| 1 | “XYZ” |
| 2 | “service provider” |
| 3 | “Jan. 1, 2015” |
| 4 | “customer production ready date” |
| . . . | . . . |

In Step 420, a first context feature of the first entity and a second context feature of the second entity are built based on a semantic analysis. In this step, the context of the first and second entities is analyzed so as to build the first and second context features. Specifically, semantic analysis can be performed to parse the surrounding words of the first and second entities in the context, so as to extract typical words that can represent the linguistic context of the obtained entities. In some embodiments, the context of the entity can be one or more sentences in which the entity is cited in the document. For example, if “XYZ” is identified from a sentence, then this sentence can be the context of the identified “XYZ,” and other words other than “XYZ” in the sentence can be considered as surrounding words of “XYZ.”

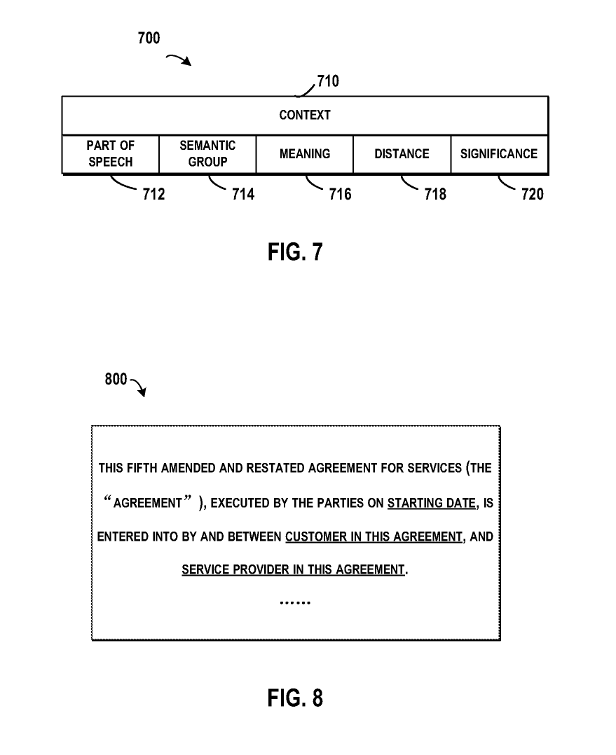

Various aspects of the context of the entity can be considered in building the context feature. For example, the type of the entity can be detected first. In one aspect, the sensitive entity and the substitute entity should belong to the same type. In the above example, as “XYZ” is a name of a company while “Jan. 1, 2015” indicates a date, it is clear that these two entities have different meanings and thus cannot be replaced with each other. In other embodiments, other aspects of the context can be considered, specifically, an aspect reflects the context of the sentence(s) where the obtained entity is cited. For example, the context feature can be represented by a vector including multiple dimensions such as {type, dependency, context, section, . . . }. Details of the context feature will be provided below with reference to FIGS. 6 and 7.

The first and second context features reflect the linguistic context of the first and second entities, and a high similarity between the first and second context features can indicate that the first and second entities have same meaning in the document. In other words, the two entities are consistent with each other.

In Step 430, it is determined if the extent of similarity between the first and second context features exceeds a predefined threshold. A criterion can be predefined for evaluating the consistency between the first and second entities. For example, depending on the rules for building the context features, various thresholds can be defined. In Step 440, the first entity is replaced with the second entity in response to a similarity determination.

Although the above embodiment illustrates building respective context features for two entities and comparing the respective context features, multiple entities can be obtained in Step 410 and a context feature can be built for each of the obtained entities in Step 420. For example, with respect to the four entities illustrated in the above Table 2, four context features can be built respectively. Any two from the four context features can be compared to check the consistency between two entities.

Usually, a document can include tens of or even hundreds of pages, thus a great number of potential entities can be obtained from the document. In this situation, stricter criteria can be predefined for filtering out irrelevant ones from the obtained entities. For example, it can be defined that only entities being associated with an organization, a date, a location, a person, a number or a currency are identified from the document.

In one embodiment of the present invention, a first term and a second term can be retrieved from the document based on the lexical analysis. Then, the first and second terms can be identified as the first and second entities respectively if the first and second terms are associated with at least one of an organization, a date, a location, a person, a number and a currency. In this step, the filtering rule can be specified according to the definition of the target information.

In the embodiment, various algorithms can be applied in identifying the first and second terms. For example, if the amount of money is concerned by the user, the target information can be defined as prices, service fees and the like, then keywords can be set to “price,” “fee,” “$,” “USD” and other terms so as to identify meaningful entities based on the search result. As a result, terms such as “unit price” and “USD 1000.00” can be identified from the document. For another example, if the target information relates to dates, then keywords can be set to “date,” “January,” “February,” and other terms indicating a date. In this example, terms such as “customer production ready date” and “Jan. 1, 2015” can be identified from the documents. Based on the above principle, appropriate steps can be worked out for identifying the first and second entities.

Usually, the document can include multiple chapters and each chapter can further include multiple sections and sub-sections. Generally, occurrences of the entity in the same chapter/section tend to have similar meaning, while occurrences of the entity in different chapters/sections can possibly have different meaning. For example, for a tripartite contract defining responsibilities for three parties, “Chapter III Responsibilities for the buy side” and “Chapter IV Responsibilities for the sell side” exist in the contract. In this contract, the word “XYZ” cited in Chapters III and IV can actually refer to “the buy side” and “the sell side” respectively. As occurrences of the same entity can possibly have different meaning in different paragraphs, the document can be divided into small portions such that the context feature of the entity can be built based on the paragraphs in each portion.

In one embodiment of the present invention, the document can be divided into at least two fragments based on a hierarchical structure of the document. Then the first and second entities can be obtained from one of the at least two fragments respectively, next the first and second context features can be built based on the fragments of the at least two fragments respectively.

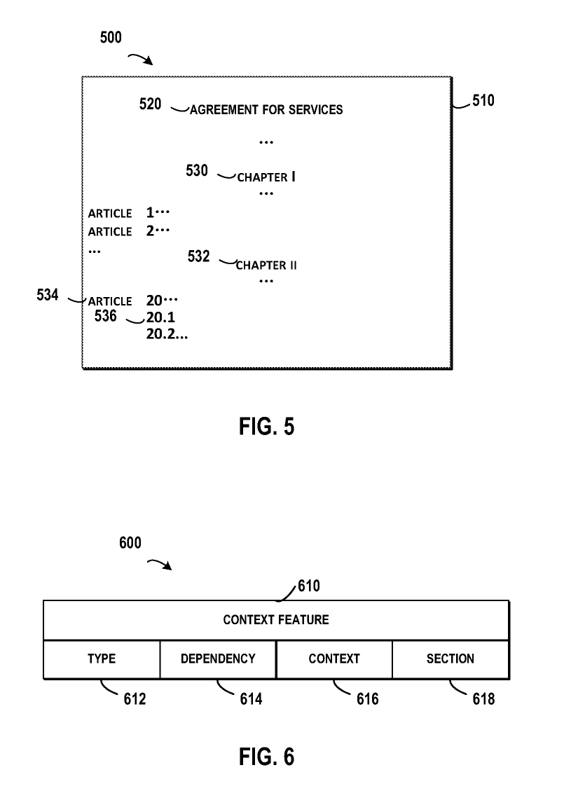

FIG. 5 schematically illustrates a diagram of a hierarchical structure of a document according to one embodiment of the present invention. Document 510 can include multiple hierarchical levels, for example, the title of the document 510 “AGREEMENT FOR SERVICES” can represent a first level of document 510. Further, document 520 can include several chapters. In this figure, “CHAPTER I” 530 and “CHAPTER II” 532 can represent a second level of document 510, “ARTICLE 20” 534 and “20.1” 536 can respectively represent a third level and a fourth level of document 510.

In embodiments of the present invention, the document can be saved in different formats. In one format, the hierarchical structure is saved in the document. For example, with respect to a “.doc” file, the hierarchical structure is saved in the document and thus it can be directly obtained from the document. In another format, no hierarchical structure is provided. For example, in a “.txt” file, keywords such as “chapter,” “article” and the like can be searched in the document so as to extract the hierarchical structure from the document.

With the above method, the document can be divided into fragments based on the hierarchical structure. For example, the document can be divided according to the chapters in the document. At this point, the first and second entities can be identified from one chapter of the document. In this embodiment, as occurrences of the same entity identified from one chapter tend to have the same meaning, the context feature built from the identified entity is more likely to represent the context of the identified entity.

Continuing the above example, if “XYZ” is identified from both Chapters III and IV, the occurrences of “XYZ” in Chapters III can actually refer to “the buy side” and the occurrences of “XYZ” in Chapters IV can actually refer to “the sell side.” If the context feature of “XYZ” is built by a semantic analysis of these two chapters, then the context feature in fact relates to context of both “the buy side” and “the sell side.” In other words, the context feature includes too much noise, and thus is not qualified for being the context feature of either “the buy side” or “the sell side.” If the document is divided into multiple fragments and the entity is identified from a single fragment, then the entity of “XYZ” can represent “the buy side” throughout Chapter III of the document. Further, Chapter III can be used for building the context feature of “XYZ.” In turns, the context feature built from a semantic analysis of Chapter III can be more appropriate for “the buy side.”

It would be appreciated that the document can include several articles and detailed information of some articles can be further defined in another document. In this event, the content in the other document can also be considered in obtaining the first and second entities.

In one embodiment of the present invention, another document referred to by the document can be obtained. Then the fragment can be aligned to another fragment in the other document. Next the first and second entities can be obtained from the fragment and the other fragment. In one example, the document is divided into several articles and each article is used as bases for the identifying step. If reference relationship such as “special conditions for the service provider is defined in Article 2 in ATTACHMENT AAA” is directly cited in Article 1 of the document, then “ATTACHMENT AAA” can be considered in the identifying step. Further, Article 1 in the document can be aligned to Article 2 in ATTACHMENT AAA. Accordingly, “the service provider” can be identified from Article 1 in the document and Article 2 in ATTACHMENT AAA.

In embodiments of the present invention, the context feature can represent the typical context of occurrences of the obtained entity, and the context feature can be evaluated from various aspects of the document. Reference is made to FIG. 6, which schematically illustrates a block diagram of a data structure of a context feature according to one embodiment of the present invention. In this figure, the context feature 610 can be defined as a vector including at least one dimension.

Context feature 610 in FIG. 6 includes four dimensions. Type dimension 612 can represent a predefined type of the identified entity. For example, the name of the company “XYZ” can belong to a type of “organization,” and “Jan. 1, 2015” can belong to a type of “date.”

Dependency dimension 614 can represent a dependency structure of a sentence in which the identified entity is cited. For example, in a sentence “ . . . Service Provider will begin delivering Services . . . ” from the document, “Service Provider” is the subject of the sentence, “deliver” is the predicate and “the service” is the object. Accordingly, the predicate and the object define a dependency structure.

Context dimension 616 can be built from the words cited in the document and the weights of each word, and details of this dimension will be described with reference to FIG. 7 hereinafter.

Further, section dimension 618 can represent an indicator of a section in which the entity is cited. For example, a granularity of the section can be predefined, and if “XYZ” is defined in a clause of “Transition Plan and Transition Services,” then section dimension 618 can be set to “Transition Plan and Transition Services.”

Although FIG. 6 illustrates four dimensions in the context feature, it would be appreciated that the context feature can include more or less dimensions according to the content of the document. For example, in a document including lots of acronyms, the context feature can further include a dimension indicating the full text of the acronym.

Referring back to Table 2, entities such as “XYZ,” “Jan. 1, 2015,” “service provider,” and “customer production ready date” are identified from the document. Details for building the context feature for these identified entities will be described hereinafter.

In one embodiment of the present invention, each of the first and second context features can include a type dimension. Types of the first and second entities can be obtained based on the semantic analysis, respectively. Then the types of the first and second entities can be included in the first and second context features, respectively.

In this embodiment, the type can include an organization, a date, a location, a person, a number and a currency. As both of “XYZ” and “the service provider” belong to organizations, the type dimensions of both of “XYZ” and “the service provider” can be set to “organization.” With the above steps, the dependency dimension of the context features of “XYZ,” “service provider,” “Jan. 1, 2015,” and “customer production ready date” are generated and then illustrated in Table 3.

TABLE 3
Type Dimension

| No. | Entity | Type Dimension |
|---|---|---|
| 1 | “XYZ” | organization |
| 2 | “service provider” | organization |
| 3 | “Jan. 1, 2015” | date |
| 4 | “customer production | date |
| | ready date” | |
| . . . | . . . | . . . |

Since the type reflects a general concept of the identified entities, in one embodiment, the types of the first and second entities can be compared first so as to reduce the workload in further steps. For example, if “XYZ” and “Jan. 1, 2015” are compared, considering the type of “XYZ” (“organization”) and that of “Jan. 1, 2015” (“date”) are different, the workflow can be stopped.

In one embodiment of the present invention, each of the first and second context features includes a dependency dimension. Based on the semantic analysis, predicates and objects of the first and second entities can be obtained from sentences in which the first and second entities are cited in the document, respectively. Then, the predicates and objects of the first and second entities can be included in the first and second context features, respectively.

In building the context feature, the document can be segmented into sentences, and then each sentence can be processed. Specifically, each word in the sentence can be recognized and then lemma form for each word can be built. For example, “provide” can be the lemma form of “provides,” “providing,” and “provided.” With the above steps, main idea of a sentence can be extracted.

Continuing the above example, “the service provider” is identified from a sentence in paragraph [0100] “ . . . Supplier shall provide the Services using current technologies and business processes that are consistent with the industry established standards and practices of well-managed outsourcing service providers providing services similar to . . . .” From this sentence, a dependency structure of “service providers provide service” can be obtained, wherein “provide” is the predicate and “service” is the object. Similarly, another dependency structure of “service providers perform services” can be obtained from the sentence in which “service provider” is cited. In this dependency structure, “perform” is the predicate and “service” is the object. Accordingly, the dependency dimension of “service provider” can be “[{predicate, “provide”}, {predicate, “perform”}, {predicate, “deliver”}, {predicate, “migrate”}, {object, “service”}, {object, “standard”}].”

Similarly, the dependency dimension of the context features of “XYZ,” “service provider,” “Jan. 1, 2015,” and “customer production ready date” are generated and illustrated in Table 4.

TABLE 4
Dependency Dimension

| No. | Entity | Dependency Dimension |
|---|---|---|
| 1 | “XYZ” | [{predicate, “deliver”}, |
| | | {predicate, “migrate”}, |
| | | {object, “service”}, |
| | | {object, “process”},] |
| 2 | “service provider” | [{predicate, “provide”}, |
| | | {predicate, “perform”}, |
| | | {predicate, “deliver”}, |
| | | {predicate, “migrate”}, |
| | | {object, “service”}, |
| | | {object, “standard”}] |
| 3 | “Jan. 1, 2015” | [{predicate, “complete”}, |
| | | {subjective, “testing”}, |
| | | {subjective, “end_user”}] |
| 4 | “customer production | [{predicate, “complete”}, |
| | ready date” | {subjective, “testing”}, |
| | | {subjective, “end_user”}] |
| . . . | . . . | . . . |

It would be appreciated that the context of the identified entity can relate to several aspects of the sentence in the document, and thus at least one aspect of a surrounding word in a sentence where the each entity is cited can be considered. In one embodiment of the present invention, each of the first and second context features can include a context dimension. Context vectors for the first and second entities can be created based on at least one aspect of the surrounding words of the first and second entities respectively: part of speech, a semantic group, meaning, distance to the first and second entities, and a significance value. In this embodiment, the surrounding words are cited in sentences where the first and second entities are cited. Then, the context vectors of the first and second entities can be included in the first and second context features, respectively.

Reference will be made to FIG. 7, which schematically illustrates a block diagram of a data structure of a context dimension according to one embodiment of the present invention. In FIG. 7, context dimension 710 can be represented by a vector including several dimensions. Each of the dimensions can reflect one aspect of the surrounding words of the identified entity. Paragraph [0110] is analyzed for building the context dimension of “XYZ.” In the sentence in which “XYZ” is cited, all the words other than “XYZ” can be the surrounding words of “XYZ.” For example, the surrounding word can be “all,” “services,” “and,” . . . “months.” In this embodiment, various aspects of each surrounding word can be considered in building the context dimension.

Part of speech 712 of each surrounding word can be detected. Paragraph [0110] is analyzed for building the context dimension of “XYZ,” the first word “all” in [0110] paragraph [0110] is an adjective and the second word “service” is a noun. Scores can be predefined for various types, for example, a score of an adjective can be set to 0.8, and a score of a noun can be set to 1. Then, part of speech 712 of each surrounding word can be indicated by the above score.

Semantic group 714 can refer to the semantic classification of the surrounding word. For example, “all” and “service” can be a portion of the subject in the sentence. Based on a predefined rule, semantic group 714 can be set to a score according to the semantic classification.

Further, meaning 716 can refer to whether the surrounding word being a dumb word. For example, the words such as “will,” “can,” “have been,” and the like can be considered as dumb words and thus can be neglected in exacting the main idea from the sentence.

Moreover, distance 718 can refer to the distance between the surrounding word and the identified entity. For example, as “XYZ” is the sixteenth word in the sentence, the distance of the first word “all” and “XYZ” can be set to: 16−1=15.

Furthermore, significance 720 can refer to a significance degree of the surrounding word in the document. With respect to documents in different field, the same word can be set to different scores. For example, the surrounding word “deliver” in a technical document can be set to a low score, while in a contact it can be of great significance and thus can be set to a high score.

The above descriptions illustrate five aspects of the surrounding word based on which context dimension 710 is built. It would be appreciated that each aspect can be set to a score for indicating the attribute of the surrounding word in the each aspect. Then, a normalized sum can be calculated from weighted scores to indicate context dimension 710. With respect to the surrounding word “center” in paragraph [0110], the five aspects can be represented by a vector {center, (1, 1, 1, 1, 1)}. Finally, the context dimension for “center” can be represented as {center, 1} after a normalization step. Further, other surrounding words of “XYZ” in the paragraph can be analyzed and the context dimension for “data” can be represented as {data, 1}. Next, the surrounding words can be sorted according to an alphabetical order or possibly other orders for further comparing.

It would be appreciated that the context dimension can possibly include portions of the surrounding words. For example, for the first word “all” in paragraph [0110], if the score for “all” calculated according to the above five aspects can be lower than a predefined threshold, the word “all” can be cancelled from the final context dimension.

Based on the above steps, the sentences relates to “XYZ,” “service provider,” “Jan. 1, 2015,” and “customer production ready date” can be analyzed and context dimension of the context features of “XYZ,” “service provider,” “Jan. 1, 2015,” and “customer production ready date” are generated and illustrated in Table 5.

TABLE 5
Context Dimension

| No. | Entity | Context Dimension |
|---|---|---|
| 1 | “XYZ” | [{center:1}, {data:1}, {deliver:1}, {effective:1}, |
| | | {methodology:1}, {migrate:1}, {month:1}, {process:1}, |
| | | {service:1}, {transition:1}] |
| 2 | “service provider” | [{accordance:0.23}, {activity:0.78}, {advantage:0.15}, |
| | | {agreement:1.35}, {applicable:1.24}, {business:0.82}, |
| | | {center:0.15}, {contract:0.82}, {cost:1.10}, |
| | | {customer:1.39}, {date:1.32}, {delivery:0.96}, |
| | | {effective:0.95}, {efforts:0.96}, {environment:1.10}, |
| | | {governance:0.78}, {implementation:0.82}, |
| | | {industry:1.39}, {maintain:0.45}, {methodology:0.82}, |
| | | {migrate:1.39}, {month:1.10}, {nature:0.15}, |
| | | {outsource:0.40}, {practice:1.10}, {price:1.32}, |
| | | {process:1.24}, {provide:1.40}, {quality:0.85}, |
| | | {rate:0.78}, {recipient:0.82}, {service:1.50}, |
| | | {standard:0.85}, {supplement:1.37}, {supplier:1.10}, |
| | | {technology:0.51}, {transition:1.32}, {volume:0.63}, |
| | | {workload:0.78}, {year:0.23}] |
| 3 | “Jan. 1, 2015” | [{application:0.78}, {begin:0.61}, {complete:0.78}, |
| | | {enable:0.61}, {end_user:0.61}, {load:0.73}, |
| | | {monitor:0.67}, {notify:1.06}, {pursuant:0.73}, |
| | | {report:0.67}, {section:0.73}, {service:0.54}, |
| | | {test:0.73}, {write:1.10} ] |
| 4 | “customer production | [{application:0.67}, {begin:0.54}, {complete:1.08}, |
| | ready date” | {content:0.61}, {customer:1.31}, {enable:0.54}, |
| | | {end_user:0.54}, {follow:1.08}, {hosting:0.78}, |
| | | {load:0.67}, {monitor:0.61}, {notify:1.08}, {ready:0.78}, |
| | | {report:0.54}, {service:1.10}, {test:0.67}] |
| . . . | . . . | . . . |

In one embodiment of the present invention, each of the first and second context features can include a section dimension. Based on the semantic analysis, indicators of sections in which the first and second entities are cited can be obtained from the document, respectively. Then, the indicators of the first and second entities can be included in the first and second context features, respectively.

For example, if it is determined that “XYZ” is defined in the clause of “Transition Plan and Transition Services,” and “service provider” is defined in the clause of “Transition Plan and Transition Services” and “Multiple Service Levels,” then the section dimensions can be set to corresponding values. With the above steps, the section dimension of the context features of “XYZ,” “service provider,” “Jan. 1, 2015,” and “customer production ready date” are illustrated in Table 6.

TABLE 6
Section Dimension

| No. | Entity | Section Dimension |
|---|---|---|
| 1 | “XYZ” | “Transition Plan and Transition Services” |
| 2 | “service provider” | “Transition Plan and Transition Services” |
| | | “Multiple Service Levels” |
| 3 | “Jan. 1, 2015” | “Definition” |
| 4 | “customer production | “Definition” |
| | ready date” | |
| . . . | . . . | . . . |

Although multiple dimensions are included in the context feature in the above descriptions, it would be appreciated that the context feature can include fewer dimensions. Additionally or alternatively, the context feature can include more dimensions. The above descriptions illustrate the detailed steps for building a first context feature and a second context feature for the first and second entities respectively, and then the first and second context features can be compared to determine a similarity therebetween. For example, a Euclidean distant can be adopted in determining the similarity between the first and second context features. For example, for the identified entities “Jan. 1, 2015” and “customer production ready date,” each of the dimensions illustrated in Tables 3-6 can be compared respectively to obtain a Euclidean distant between “Jan. 1, 2015” and “customer production ready date.”

With respect to each dimension in the context feature, a Jaccard Index can be used in calculating the distant for the each dimension. Jaccard Index, which is also known as the Jaccard similarity coefficient, is a statistic used for comparing the similarity and diversity of two sample sets (for example, the above mentioned A1 and A2). The Jaccard Index measures similarity between the sample sets, and is defined as the size of the intersection divided by the size of the union of the sample sets as below:

$$Jaccard Index ( A 1 , A 2 ) = \frac{\vert A 1 ⋂ A 2 \vert}{\vert A 1 ⋃ A 2 \vert} \qquad ( 1 )$$

Referring back to Table 3, as the type dimensions for the two entities are “date,” the distance for type dimension can be 0. Referring back to Table 4, as the dependency dimensions for the two entities are “[{predicate, “complete”}, {subjective, “testing”}, {subjective, “end_user”}],” the distance for dependency dimension can be 0.

Referring back to Table 5, for simplicity, only the words are considered while the weights for these words are neglected. The context dimension of “Jan. 1, 2015” includes 14 words, the context dimension of “customer production ready date” includes 16 words, and the intersection of the context dimensions for the two entities includes 10 words (application, begin, complete, end_user, load, monitor, notify, report, service, test). The distance for the context dimension can be determined by:

$$Jaccard Index ( A 1 , A 2 ) = \frac{\vert 10 \vert}{\vert 14 + 16 - 10 \vert} = 0.5$$

In another embodiment, the weight of each word can be considered in determining the distance for context dimension, and other rules can be defined in determining the distance.

Referring back to Table 6, as the section dimensions for the two entities are “Definition,” the distance for the section dimension can be 0.

From the above descriptions, the Euclidean distance between the context features of “Jan. 1, 2015,” and “customer production ready date” can be represented with a vector (0, 0, 0.5, 0). Further, the vector can be normalized to:

$$Normalization ( 0 , 0 , 0.5 , 0 ) = \frac{0 * 1 + 0 * 1 + 0.5 * 1 + 0 * 1}{1 + 1 + 1 + 1} = 0.125$$

In one embodiment of the present invention, a criterion can be predefined and the replacing step can be triggered in response to the Euclidean distance satisfying the predefined criterion. For example, a threshold can be predefined to a value of 0.2. In this example, as the Euclidean distance 0.125 is less than the threshold 0.2, it indicates that the difference between the context features of “Jan. 1, 2015” and “customer production ready date” is less than the predefined threshold. Accordingly, the date of “Jan. 1, 2015” can be replaced with “customer production ready date” such that the actual date of the customer production ready date can be preserved from the document.

In one embodiment of the present invention, the first and second entities can be compared to determine which one is the general concept of the other. If the second entity indicates the general concept of the first entity, then an occurrence of the first entity in the document can be replaced with the second entity. Continuing the above example, as “service provider” is a general concept of the name of the company “XYZ” and “customer production ready date” is a general concept of “Jan. 1, 2015,” then “XYZ” can be replaced with “service provider” and “Jan. 1, 2015” can be replaced with “customer production ready date.”

FIG. 8 schematically illustrates an example document resulting from the example document illustrated in FIG. 2 according to one embodiment of the present invention. It is seen that the date of “Jun. 30, 2015” is replaced by “starting date,” “ABC Service Company, Inc.” is replaced by “customer in this agreement,” and “XYZ Corporation” is replaced by “service provider in this agreement.”

With the technical solutions of the present invention, the predefined target information can be preserved from the document. On one hand, the target information can be replaced by a general concept of the details of the target information, such that the information such as trade secrets and technical parameters can be removed from the document. On the other hand, the processed document stands fluent and readable to the reader.

Various embodiments implementing the method of the present invention have been described above with reference to the accompanying drawings. Those skilled in the art will understand that the method can be implemented in software, hardware or a combination of software and hardware. Moreover, those skilled in the art can understand by implementing steps in the above method in software, hardware or a combination of software and hardware, there can be provided an apparatus/system based on the same invention concept. Even if the apparatus/system has the same hardware structure as a general-purpose processing device, the functionality of software contained therein makes the apparatus/system manifest distinguishing properties from the general-purpose processing device, thereby forming an apparatus/system of the various embodiments of the present invention. The apparatus/system described in the present invention includes several means or modules, the means or modules configured to execute corresponding steps. Upon reading this specification, those skilled in the art can understand how to write a program for implementing actions performed by these means or modules. Since the apparatus/system is based on the same invention concept as the method, the same or corresponding implementation details are also applicable to means or modules corresponding to the method. As detailed and complete description has been presented above, the apparatus/system is not detailed below.

According to one embodiment of the present invention, a computing system is proposed. The computing system includes: a processor device coupled to a computer-readable memory unit, the memory unit including a module having instructions that when executed by the computer processor implements a method. The method includes: obtaining a first entity and a second entity from a document, building a first context feature from the first entity and a second context feature from the second entity based on a semantic analysis, determining that the extent of similarity between the first and second context features exceeds a predefined threshold, and replacing the first entity with the second entity in response to similarity determination.

In one embodiment of the present invention, obtaining the first and second entities from the document can be implemented in the following way. First, a first term and a second term can be retrieved from the document based on the lexical analysis. Then, the first and second terms can be identified as the first and second entities respectively in response to the first and second terms being associated with at least one of an organization, a date, a location, a person, a number and a currency.

In one embodiment of the present invention, the document can be divided into at least two fragments based on a hierarchical structure of the document. Then, each of the first and second entities can be identified from one of the at least two fragments respectively. Next, the first and second context features can be built based on the fragments of the at least two fragments respectively.

In one embodiment of the present invention, an incorporated document referred to by the document can be obtained. Then, the fragment can be aligned to an incorporated fragment in the other document. Next, the first and second entities can be obtained from the fragment and the incorporated fragment.

In one embodiment of the present invention, types of the first and second entities can be obtained based on the semantic analysis, respectively. Then, the types of the first and second entities can be included in the first and second context features, respectively.

In one embodiment of the present invention, based on the semantic analysis, predicates and objects of the first and second entities can be obtained from sentences in which the first and second entities are cited in the document, respectively. Then, the predicates and objects of the first and second entities can be included in the first and second context features, respectively.

In one embodiment of the present invention, context vectors for the first and second entities can be created based on at least one aspect of surrounding words of the first and second entities respectively: part of speech, a semantic group, meaning, distance to the first and second entities, and a significance value, the surrounding words being cited in sentences where the first and second entities are cited. Then, the context vectors of the first and second entities can be included in the first and second context features, respectively.

In one embodiment of the present invention, based on the semantic analysis, indicators of sections in which the first and second entities are cited can be obtained from the document, respectively. Then, the indicators of the first and second entities can be included in the first and second context features, respectively.

In one embodiment of the present invention, the second entity can be determined being a general concept of the first entity. Then, an occurrence of the first entity in the document can be replaced with the second entity.

According to one embodiment of the present invention, a computer readable non-transitory article of manufacture tangibly embodying computer readable instructions which, when executed, cause a computer to carry out the steps of a method. The method includes: obtaining a first entity and a second entity from a document, building a first context feature of the first entity and a second context feature of the second entity based on a semantic analysis, determining that the extent of similarity between the first and second context features exceeds a predefined threshold, and replacing the first entity with the second entity in response to similarity determination.

In one embodiment of the present invention, the computer readable non-transitory article of manufacture, wherein the method further includes the steps of: retrieving from the document a first term and a second term based on the lexical analysis; and identifying the first and second terms as the first and second entities respectively in response to the first and second terms being associated with at least one of an organization, a date, a location, a person, a number and a currency.

In one embodiment of the present invention, the computer readable non-transitory article of manufacture, wherein the method further includes the steps of: dividing the document into at least two fragments based on a hierarchical structure of the document; and identifying each of the first and second entities from one of the at least two fragments respectively, thereby producing the first and second context features based on the fragments of the at least two fragments, respectively.

In one embodiment of the present invention, the computer readable non-transitory article of manufacture, wherein the method further includes the steps of: obtaining an incorporated document referred to by the document; align the fragment to an incorporated fragment in the incorporated document; and obtaining the first and second entities from the fragment and the incorporated fragment.

In one embodiment of the present invention, the computer readable non-transitory article of manufacture, wherein the method further includes the steps of: obtaining types of the first and second entities based on the semantic analysis, respectively; and including the types of the first and second entities in the first and second context features, respectively.

In one embodiment of the present invention, the computer readable non-transitory article of manufacture, wherein the method further includes the steps of: obtaining predicates and objects of the first and second entities from sentences in which the first and second entities are cited in the document based on the semantic analysis, respectively; and including the predicates and objects of the first and second entities in the first and second context features, respectively.

In one embodiment of the present invention, the computer readable non-transitory article of manufacture, wherein the method further includes the steps of: creating context vectors for the first and second entities based on at least one aspect of surrounding words of the first and second entities respectively: part of speech, a semantic group, meaning, distance to the first and second entities, and a significance value, the surrounding words being cited in sentences where the first and second entities are cited; and including the context vectors of the first and second entities in the first and second context features, respectively.

In one embodiment of the present invention, the computer readable non-transitory article of manufacture, wherein the method further includes the steps of: obtaining from the document indicators of sections in which the first and second entities are cited based on the semantic analysis, respectively; and including the indicators of the first and second entities in the first and second context features, respectively.

In one embodiment of the present invention, the computer readable non-transitory article of manufacture, wherein the method further includes the steps of: determining the second entity is a general concept of the first entity; and replacing an occurrence of the first entity in the document with the second entity.

Moreover, the system can be implemented by various manners, including software, hardware, firmware or a random combination thereof. For example, in some embodiments, the apparatus can be implemented by software and/or firmware.

Alternatively or additionally, the system can be implemented partially or completely based on hardware. for example, one or more units in the system can be implemented as an integrated circuit (IC) chip, an application-specific integrated circuit (ASIC), a system on chip (SOC), a field programmable gate array (FPGA), etc. The scope of the present intention is not limited to this aspect.

The present invention can be a system, an apparatus, a device, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams can represent a module, snippet, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for preserving sensitive information in a confidential document, the method comprising:
obtaining a first entity and a second entity from a document;
building a first context feature from the first entity and a second context feature from the second entity based on a semantic analysis;
determining that the extent of similarity between the first and second context features exceeds a predefined threshold; and thereafter
replacing the first entity with the second entity in response to similarity determination.

2. The method of claim 1, wherein obtaining the first and second entities from the document comprises:
retrieving a first term and a second term from the document based on a lexical analysis; and
identifying the first term as the first entity and the second term as the second entity in response to the first and second terms being associated with at least one of the following: an organization, a date, a location, a person, a number and a currency.

3. The method of claim 1, wherein obtaining the first and second entities from a document comprises:
dividing the document into at least two fragments based on a hierarchical structure of the document;
identifying each of the first and second entities from one of the at least two fragments; and
building the first context feature from the first entity and the second context feature from the second entity based on a semantic analysis of the fragments of the at least two fragments.

4. The method of claim 3, wherein obtaining the first and second entities from a document further comprises:
obtaining an incorporated document referred to by the document;
aligning a fragment of the at least two fragments from the document to an incorporated fragment from the incorporated document; and
obtaining the first and second entities from the fragment and the incorporated fragment.

5. The method of claim 1, wherein building the first and second context features comprises:
obtaining types of the first entity and second entity based on a semantic analysis; and
including the types of the first entity and second entity in the first and second context features, respectively.

6. The method of claim 1, wherein building the first and second context features comprises:
obtaining predicates and objections of the first entity and second entity from sentences in which the first entity and second entity are cited in the document based on the semantic analysis; and
including the predicates and objects of the first entity and second entity in the first and second context features, respectively.

7. The method of claim 1, wherein building the first and second context features comprises:
creating context vectors for the first and second entities based on at least one aspect of the surrounding words cited in the same sentences of each entity such as:
(i) part of speech,
(ii) semantic group,
(iii) meaning,
(iv) distance to the first and second entities, and
(v) a significance value; and
including the context vectors of the first and second entities in the first and second context features, respectively.

8. The method of claim 1, wherein building the first and second context features comprises:
obtaining indicators of sections from the document in which the first and second entities are cited based on the semantic analysis; and
including the indicators of the first and second entities in the first and second context features, respectively.

9. The method of claim 1, wherein replacing the first entity with the second entity comprises:
determining that the second entity is a general concept for the first entity; and
replacing an occurrence of the first entity in the document with the second entity.

10. A computing system comprising a processor device coupled to a computer-readable memory unit, the memory unit comprising a module having instructions that when executed by the processor device implements a method comprising:
obtaining a first entity and a second entity from a document;
building a first context feature from the first entity and a second context feature from the second entity based on a semantic analysis;
determining that the extent of similarity between the first and second context features exceeds a predefined threshold; and thereafter
replacing the first entity with the second entity in response to similarity determination.

11. The computing system of claim 10, wherein obtaining the first and second entities from the document comprises:
retrieving a first term and a second term from the document based on the lexical analysis; and
identifying the first term as the first entity and the second term as the second entity in response to the first and second terms being associated with at least one of the following: an organization, a date, a location, a person, a number and a currency.

12. The computing system of claim 10, wherein obtaining the first and second entities from the document comprises:
dividing the document into at least two fragments based on a hierarchical structure of the document; and
identifying each of the first and second entities from one of the at least two fragments; and
building the first context feature from the first entity and a second context feature from the second entity based on a semantic analysis of the fragments of the at least two fragments.

13. The computing system of claim 12, wherein obtaining the first and second entities from the document further comprises:
obtaining an incorporated document referred to by the document;
aligning a fragment of the at least two fragments from the document to an incorporated fragment from the incorporated document; and
obtaining the first and second entities from the fragment and the incorporated fragment.

14. The computing system of claim 10, wherein building the first and second context features comprises:
obtaining types of the first entity and second entity based on a semantic analysis; and
including the types of the first entity and second entity in the first and second context features, respectively.

15. The method of claim 10, wherein building the first and second context features comprises:
obtaining predicates and objects of the first entity and second entity from sentences in which the first entity and second entity are cited in the document based on the semantic analysis; and
including the predicates and objects of the first entity and second entity in the first and second context features, respectively.

16. The computing system of claim 10, wherein building the first and second context features comprises:
creating context vectors for the first and second entities based on at least one aspect of the surrounding words cited in the same sentences of each entity such as:
(i) part of speech,
(ii) semantic group,
(iii) meaning,
(iv) distance to the first and second entities, and
(v) a significance value; and
including the context vectors of the first and second entities in the first and second context features, respectively.

17. The computing system of claim 10, wherein building the first and second context features comprises:
obtaining indicators of sections from the document in which the first and second entities are cited based on the semantic analysis, respectively; and
including the indicators of the first and second entities in the first and second context features, respectively.

18. A computer readable non-transitory article of manufacture tangibly embodying computer readable instructions which, when executed, cause a computer to carry out the steps of a method comprising:
obtaining a first entity and a second entity from a document;
building a first context feature from the first entity and a second context feature from the second entity based on a semantic analysis;
determining that the extent of similarity between the first and second context features exceeds a predefined threshold; and thereafter
replacing the first entity with the second entity in response to similarity determination.

19. The computer readable non-transitory article of manufacture of claim 18, wherein the method further comprises the steps of:
retrieving a first term and a second term from the document based on the lexical analysis; and
identifying the first term as the first entity and the second term as the second entity in response to the first and second terms being associated with at least one of the following: an organization, a date, a location, a person, a number and a currency.

20. The computer readable non-transitory article of manufacture of claim 19, wherein the method further comprises the steps of:
dividing the document into at least two fragments based on a hierarchical structure of the document; and
identifying each of the first and second entities from one of the at least two fragments, respectively, thereby producing the first and second context features based on the fragments of the at least two fragments, respectively.
